(19) United States
(12) Patent Application Publication
(10) Pub. No.: US 2017/0210158 A1
(43) Pub. Date: Jul. 27, 2017

(54) PRINTING APPARATUS, PRINTING METHOD, AND PRINTED MATTER

(71) Applicant: SEIKO EPSON CORPORATION, Tokyo (JP)

(72) Inventors: Kazuaki SAKURADA, Suwa, Nagano (JP); Kentaro MIYAZAKI, Matsumoto, Nagano (JP); Satoru KATAGAMI, Matsumoto, Nagano (JP); Yuichi WASHIO, Matsumoto, Nagano (JP); Kazuya TAJIMA, Matsumoto, Nagano (JP)

(21) Appl. No.: 15/328,202

(22) PCT Filed: Jul. 21, 2015
(86) PCT No.: PCT/JP2015/003658

§ 371 Date: Jan. 23, 2017

(30) Foreign Application Priority Data
Jul. 28, 2014 (JP) 2014-152639

(51) Int. Cl. B41M 5/50; B41J 2/21; B41M 5/00; B41J 2/14

(52) U.S. Cl. CPC B41M 5/502; B41J 2/1433; B41J 2/21; B41M 5/0017

(57) ABSTRACT

A printing apparatus executes a continuous printing by a printing execution unit while transporting a belt-shaped printing base material by a transport path in a longer direction. The printing execution unit includes a reaction solution discharge head, an ink discharge head, and a head for overprinting. The reaction solution discharge head forms a reaction solution layer containing a flocculant on a printing face of the printing base material. The ink discharge head forms a printing image by discharging an ink containing a color material on the reaction solution layer. The head for overprinting forms an overprint layer so as to be positioned on the reaction solution layer.

### CROSS-REFERENCE TO RELATED APPLICATIONS

The entire disclosure of Japanese Patent Application No. 2014-152639, filed Jul. 28, 2014 is expressly incorporated by reference herein.

### TECHNICAL FIELD

The present invention relates to a printing apparatus, a printing method, and a printed matter.

### BACKGROUND ART

As a printing apparatus, an ink jet printer that forms an image by discharging an ink droplet onto a recording medium, is known. Among the ink jet printers, there is an ink jet printer that previously attaches a flocculant which is capable of flocculating a color material in an ink to a printing sheet or the like before discharging the ink droplet, in order to improve adherence of the ink droplet with respect to the recording medium, or to improve image quality (for example, PTL 1). In PTL 1, a pH regulating agent or a polyvalent metal salt is used as a flocculant.

### CITATION LIST

### Patent Literature

PTL 1
JP-A-2006-205677

### SUMMARY OF INVENTION

### Technical Problem

The inventors of the present invention have eagerly studied the flocculant which is most suitable in order to improve the adherence of the ink droplet with respect to the recording medium, or to improve the image quality, and found out that the flocculant has an ability to fix the color material to the recording medium by flocculating the color material which is high, but generates an off-flavor, or deliquesces when being in contact with moisture. In a case of using the flocculant having such the properties, if the flocculant remains in a printed matter as being unreacted with the color material in the ink, a possibility that the remaining flocculant may generate the off-flavor or may express adhesiveness due to the deliquescence when being in contact with the moisture, is considered. In the past, a special study relating to the generation of a failure which is caused by the flocculant remaining in the printed matter, has not been made.

### Solution to Problem

The present invention is not limited to an ink jet printer, and is made in order to solve the above-described problems in a printing technology using a flocculant, and can be realized as the following aspects.

(1) According to a first aspect of the present invention, there is provided a printing apparatus. The printing apparatus may include a first layer forming unit, an ink discharge unit, and a second layer forming unit. The first layer forming unit may be capable of forming a reaction solution layer which is a layer of a reaction solution containing a flocculant onto a recording medium. The ink discharge unit may be capable of discharging an ink containing a color material on the reaction solution layer. The second layer forming unit may be capable of forming an overprint layer which is a layer of an overprint solution so as to be positioned on the reaction solution layer, with respect to the recording medium where the ink is discharged. According to the printing apparatus of the first aspect, since contact of the flocculant in the reaction solution layer with external environments is suppressed by the overprint layer, generation of a failure including the generation of an off-flavor or expression of adhesiveness of the flocculant which is caused by the flocculant remaining in a printed matter, is suppressed.

(2) In the printing apparatus of the first aspect, the second layer forming unit may form the overprint layer, so that an outer periphery of the overprint layer overlaps with an outer periphery of the reaction solution layer, or so that an outer periphery of the overprint layer surrounds an outer periphery of the reaction solution layer. According to the printing apparatus of the first aspect, since barrier properties of the flocculant with respect to the external environments are enhanced due to the overprint layer, the generation of the failure which is caused by the flocculant remaining in the printed matter, is further suppressed.

(3) In the printing apparatus of the first aspect, the second layer forming unit may form the overprint layer by a solid coating of the overprint solution. According to the printing apparatus of the first aspect, the barrier properties of the flocculant with respect to the external environments are further enhanced due to the overprint layer.

(4) In the printing apparatus of the first aspect, the overprint solution may contain an ingredient which is capable of reacting with the flocculant. According to the printing apparatus of the first aspect, since an amount of the flocculant remaining on the recording medium after the printing is reduced, the generation of the failure which is caused by the flocculant remaining in the printed matter, is further suppressed.

(5) In the printing apparatus of the first aspect, the flocculant may contain a polyvalent metal salt. According to the printing apparatus of the first aspect, it is possible to suppress the generation of the off-flavor or the expression of the adhesiveness of the flocculant while enhancing flocculating properties of the color material in the ink.

(6) In the printing apparatus of the first aspect, the second layer forming unit may include a liquid discharge head that discharges the overprint solution. According to the printing apparatus of the first aspect, the forming of the overprint layer is simplified.

(7) The printing apparatus of the first aspect, may further include a transport path where the recording medium is transported, in which the first layer forming unit, the ink discharge unit, and the second layer forming unit may be sequentially arranged from an upstream side to a downstream side in the transport path. According to the printing apparatus of the first aspect, it is possible to efficiently form the reaction solution layer, the ink layer, and the overprint layer during the transport of the recording medium.

(8) In the printing apparatus of the first aspect, the transport path may include a rotating drum of which an outer peripheral face is capable of supporting the recording medium, and the first layer forming unit, the ink discharge unit, and the second layer forming unit may be arranged in a position which is opposite to the outer peripheral face of the rotating drum. According to the printing apparatus of the first aspect, by using the rotating drum as a platen, it is possible to efficiently form the reaction solution layer, the ink layer, and the overprint layer.

(9) The printing apparatus of the first aspect, may further include a resin layer forming unit that forms a resin layer, onto the recording medium before the reaction solution layer is formed. According to the printing apparatus of the first aspect, it is possible to enhance adhesion of the reaction solution layer, the ink layer, and the overprint layer with respect to the recording medium.

(10) According to a second aspect of the present invention, there is provided a printing method. The printing method of the second aspect, may include a first layer forming step, an ink discharging step, and a second layer forming step. The first layer forming step may form a reaction solution layer which is a layer of a reaction solution containing a flocculant onto a recording medium. The ink discharging step may discharge an ink containing a color material on the reaction solution layer. The second layer forming step may form an overprint layer which is a layer of an overprint solution on the reaction solution layer. According to the printing method of the second aspect, since the contact of the flocculant remaining in the printed matter with the external environments is suppressed by the forming of the overprint layer, the generation of the failure which is caused by the flocculant is suppressed.

(11) According to a third aspect of the present invention, there is provided a printed matter. The printed matter of the third aspect, may include a recording medium, and a printing region. The printing region may include a configuration where a reaction solution layer which is formed by a reaction solution containing a flocculant, an ink layer which is formed by an ink containing a color material, and an overprint layer which is formed by an overprint solution, are sequentially stacked from a surface of the recording medium in the recording medium. According to the printed matter, even when the flocculant remains in the printed matter, the contact of the flocculant with the external environments is suppressed by the overprint layer. Accordingly, the generation of the failure which is caused by the flocculant is suppressed.

All of a plurality of above-described components which are included in the respective aspects of the present invention are not necessary, and in order to solve a portion or all of the above-described problems, or in order to achieve a portion or all of effects which are written in the present specification, a portion of the components among the plurality of components, can be appropriately modified, deleted or replaced with new other components, and deletion of a portion of limited contents can be performed. Moreover, in order to solve the portion or all of the above-described problems, or in order to achieve the portion or all of the effects which are written in the present specification, by combining a portion or all of technical features which are included in one aspect of the present invention described above with a portion or all of technical features which are included in other aspects of the present invention described above, the combination can be one independent aspect of the present invention.

The present invention can be realized in various forms in addition to a printing apparatus, a printing method, and a printed matter. For example, the present invention can be realized in the form of a printing system including the printing apparatus, a control method of the printing apparatus, a computer program which realizes the control method, or a non-temporary recording medium which records the computer program.

### BRIEF DESCRIPTION OF DRAWINGS

FIG. 1 is a schematic diagram illustrating a configuration of a printing apparatus according to a first embodiment.

FIG. 2 is an explanatory diagram illustrating a flow of printing processing which a control unit executes.

FIG. 3 is a schematic diagram for describing a forming region of a reaction solution layer and a forming region of an overprint layer.

FIG. 4 is a schematic diagram illustrating forming processes of a printing image by a printing execution unit in sequence of the forming processes.

FIG. 5 is a schematic diagram illustrating a configuration of a printing apparatus according to a second embodiment.

FIG. 6 is a schematic diagram of a printed matter which is obtained by the printing apparatus according to the second embodiment.

### DESCRIPTION OF EMBODIMENTS

### A. First Embodiment

### Configuration of Printing Apparatus

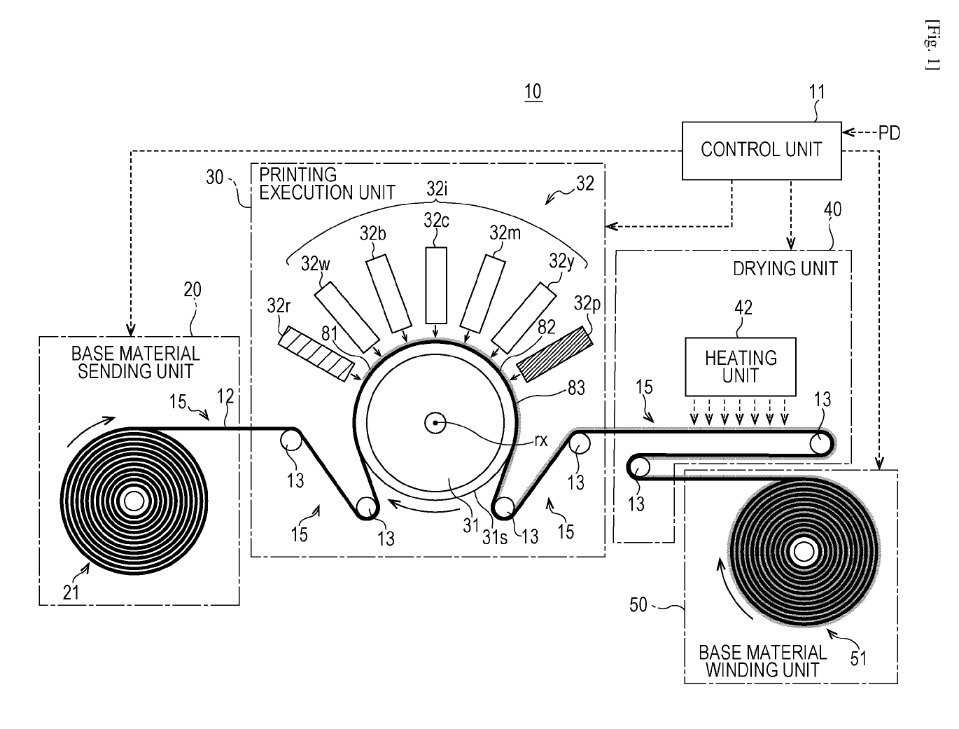

FIG. 1 is a schematic diagram illustrating a configuration of a printing apparatus 10 as a first embodiment of the present invention. The printing apparatus 10 of the first embodiment is a line printer of an ink jet system that forms an image by discharging an ink droplet onto a recording medium, and executes a continuous printing with respect to a belt-shaped printing base material 12 which is transported in a longer direction. In the first embodiment, the printing apparatus 10 is used for a label printing, and a printing face of the printing base material 12 which is the recording medium has surface texture of which absorbency of an ink is low. Therefore, the printing apparatus 10 coats a reaction solution containing a flocculant to a surface of the printing base material 12 before the ink droplet is discharged onto the printing base material 12, in order to improve fixability of the ink droplet with respect to the printing base material 12 (described in detail later). Furthermore, the printing apparatus 10 is capable of executing the printing in addition to the label printing, and is capable of using a base material, for example, glossy paper, coated paper, an OHP film or the like, as a printing base material 12. Moreover, as a printing base material 12, it is not limited to the above-described base material, and a base material such as plain paper, Japanese paper or ink jet paper of which the absorbency of liquid is high, may be used.

The printing apparatus 10 includes a control unit 11, a plurality of transport rollers 13, a base material sending unit 20, a printing execution unit 30, a drying unit 40, and a base material winding unit 50. The control unit 11 is configured by a microcomputer including a central processing unit and a main memory unit, and is capable of controlling each component of the printing apparatus 10. The control unit 11 obtains a printing data PD from the computer or the like which is connected to the outside, and executes a printing process (described later) based on the printing data PD according to a command from a user. For example, the printing data PD may be the document data where a character or a graphic is laid out, the raster data of a photographic image or the like, or the data representing the image which is created in various types of application programs.

The plurality of transport rollers 13 configure a transport path 15 of transporting the printing base material 12 in the longer direction, in the printing apparatus 10. The plurality of transport rollers 13 are suitably arranged in the printing apparatus 10 so that the base material sending unit 20, the printing execution unit 30, the drying unit 40, and the base material winding unit 50 are sequentially connected by the transport path 15. Hereinafter, the base material sending unit 20 side of the transport path 15 is referred to as “upstream side”, and the base material winding unit 50 side is referred to as “downstream side”. Each transport roller 13 supports the printing base material 12 in a shorter direction (width direction) of the printing base material 12.

The base material sending unit 20 includes a base material roller 21 where the printing base material 12 is wound in a roll shape. The base material roller 21 is rotated at a predetermined rotational speed by a motor (not illustrated) which is controlled by the control unit 11, and sends out the printing base material 12 to the printing execution unit 30 from the base material roller 21. The printing execution unit 30 includes a rotating drum 31, and a printing head unit 32, and forms a printing image on the printing face of the printing base material 12.

The rotating drum 31 is rotated at the predetermined rotational speed by the motor (not illustrated) which is controlled by the control unit 11. The rotating drum 31 transports the printing base material 12 while supporting the printing base material 12 by the surface contact with a rear face which is opposite to the printing face of the printing base material 12 on a circumferential side face 31s thereof. That is, the rotating drum 31 configures a portion of the transport path 15. In each of the upstream side and the downstream side of the rotating drum 31, the transport rollers 13 are arranged so that the tension of the longer direction can be given with respect to the printing base material 12 on the circumferential side face 31s of the rotating drum 31.

The printing head unit 32 has seven types of liquid discharge heads 32r, 32w, 32b, 32c, 32m, 32y, and 32p. In the following description, a case of being referred to as “liquid discharge heads 32r to 32p”, means all of seven liquid discharge heads 32r, 32w, 32b, 32c, 32m, 32y, and 32p. The liquid discharge heads 32r to 32p are line heads, and discharge the droplets by the size at the timing according to the command of the control unit 11.

At the time of passing through the printing head unit 32, by the discharge of the droplets from the liquid discharge heads 32r to 32p, a reaction solution layer 81, an ink layer 82, and an overprint layer 83 are sequentially formed on the surface of the printing base material 12. Functions of the liquid discharge heads 32r to 32p will be described later, in details of the respective layers 81 to 83 which are formed by the liquid discharge heads 32r to 32p.

The drying unit 40 includes a heating unit 42 where the heating temperature is controlled by the control unit 11. The drying unit 40 accepts the printing base material 12 where the reaction solution layer 81, the ink layer 82, and the overprint layer 83 are formed, from the printing execution unit 30, and promotes the drying of the above respective layers 81 to 83 due to the heating by the heating unit 42. Furthermore, in the drying unit 40, a transport distance for the drying of the respective layers 81 to 83 is secured by superimposingly reciprocating the transport path 15 in a parallel direction.

The base material winding unit 50 includes a winding roller 51 which is rotated and driven at the predetermined rotational speed according to the command of the control unit 11. The winding roller 51 winds the printing base material 12 where the respective layers 81 to 83 which are sent out from the drying unit 40 are formed. By the above configuration, the printing apparatus 10 continuously executes the printing image with respect to the printing base material 12.

### Configuration of Liquid Discharge Head

The liquid discharge heads 32r to 32p which the printing head unit 32 includes, have a liquid flow path including an accumulation space of the liquid which is a discharge target, and an element (for example, piezoelectric element or heater element) which can generate the driving power for discharging the liquid. Moreover, the liquid discharge heads 32r to 32p have a plurality of discharge ports (nozzles) which are arrayed at predetermined intervals depending on the printing resolution of the printing apparatus 10 in the width direction of the printing base material 12.

The liquid discharge heads 32r to 32p are radially arrayed with respect to a rotation axis rx of the rotating drum 31, so that each of the droplets can be discharged in a printing region of the printing base material 12, and so that each of the nozzles are opposite to the circumferential side face 31s of the rotating drum 31. That is, in the printing apparatus 10 of the first embodiment, the rotating drum 31 functions as a so-called platen. Hereinafter, each of the liquid discharge heads 32r to 32p, will be described in sequence to be arranged from the upstream side to the downstream side in the transport path 15.

A first liquid discharge head 32r corresponds to a first layer forming unit of the present invention, and forms the reaction solution layer 81 on the printing face of the printing base material 12 by discharging the droplet of the reaction solution. The reaction solution is a solution containing the flocculant which is capable of performing the flocculation reaction with a color material. In the first embodiment, as a flocculant, a polyvalent metal salt such as calcium acetate or calcium nitrate which is capable of performing the flocculation reaction with a pigment particle being the color material, is used. In the reaction solution of the first embodiment, the flocculant is contained by a concentration of approximately 1 mol/L. The reaction solution may contain the water as a solvent, a surfactant or the like, in addition to the flocculant. Moreover, as a flocculant, a polyvalent metal salt other than calcium acetate or calcium nitrate, may be used. Hereinafter, the first liquid discharge head 32r is also referred to as “reaction solution discharge head 32r”.

Five of a second liquid discharge head to a sixth liquid discharge head 32w, 32b, 32c, 32m, and 32y correspond to the ink discharge unit, and are capable of discharging the ink containing the pigment particle as a color material onto the printing base material 12. The second liquid discharge head 32w discharges the white color ink. The third liquid discharge head 32b discharges the black color ink. The fourth liquid discharge head 32c discharges the cyan color ink. The fifth liquid discharge head 32m discharges the magenta color ink. The sixth liquid discharge head 32y discharges the yellow color ink.

Hereinafter, the liquid discharge heads 32w, 32b, 32c, 32m, and 32y are respectively referred to as “ink discharge heads 32w, 32b, 32c, 32m, and 32y”. Moreover, the five ink discharge heads 32w, 32b, 32c, 32m, and 32y are combined, and the combination is referred to as “ink discharge head 32i”. By the ink discharge of the ink discharge head 32i, the ink layer 82 forming the printing image is formed on the reaction solution layer 81 of the printing base material 12.

A seventh liquid discharge head 32p corresponds to a second layer forming unit of the present invention, and forms the overprint layer 83 by discharging the droplet of an overprint solution in the printing base material 12 where the reaction solution layer 81 and the ink layer 82 are formed. Hereinafter, the seventh liquid discharge head 32p is referred to as “head for overprinting 32p”.

Here, the “overprint” in the present specification, means to form a resin film having light-transmitting properties by the addition and the drying of an ink material on the printing image. The “overprint solution” is an ink material which is used in the overprint, and the “overprint layer” means a solution layer of the ink material, or a film layer where the solution layer is dried.

In the first embodiment, as an overprint solution, a solution of dispersing at least one of the following resins in an inorganic solvent or an organic solvent is used. By using the following resin materials, the overprint layer is formed as an almost transparent film. Furthermore, the resin material which is used in the overprint solution, is not limited to the following materials.

(List of Examples of the Resins which are Contained in the Overprint Solution)

Styrene acrylic-based resin/polyethylene-based resin/urethane-based resin/polyester-based resin/acrylic-based resin/fluorine-based resin

In the printing apparatus 10 of the first embodiment, the reaction solution discharge head 32r and the head for overprinting 32p have the configuration that the nozzle resolution thereof is lower than that of the ink discharge head 32i. The “nozzle resolution” is the number of nozzles per unit area. For example, when the nozzle resolution of the ink discharge head 32i is 1200 dpi, the nozzle resolution of the reaction solution discharge head 32r and the head for overprinting 32p may be approximately 600 dpi.

The reaction solution and the overprint solution are likely to spread on the surface of the printing base material 12 in comparison with the ink. Accordingly, even in the case of lowering the nozzle resolution of the reaction solution discharge head 32r and the head for overprinting 32p, it is possible to discharge the reaction solution and the overprint solution so that the droplets which are discharged to a position adjacent to each other are connected to each other. Consequently, it is possible to form the reaction solution layer 81 and the overprint layer 83 so as to cover the region having the same area as the ink layer 82 without a gap. Moreover, if the nozzle resolution of the reaction solution discharge head 32r and the head for overprinting 32p is made to be low, it is possible to suppress that the reaction solution and the overprint solution are used in surplus. Additionally, it is possible to reduce the number of components of the reaction solution discharge head 32r and the head for overprinting 32p, and it is possible to reduce a manufacturing cost of the printing apparatus 10.

In the printing apparatus 10, in printing processing, the discharge of the droplet by the liquid discharge heads 32r to 32p with respect to the printing base material 12, is controlled by the control unit 11 on the basis of the printing data PD. Hereinafter, a flow of the printing processing by the control unit 11, and the control of the liquid discharge heads 32r to 32p by the control unit 11 in the printing processing will be described. Printing Processing in Printing Apparatus

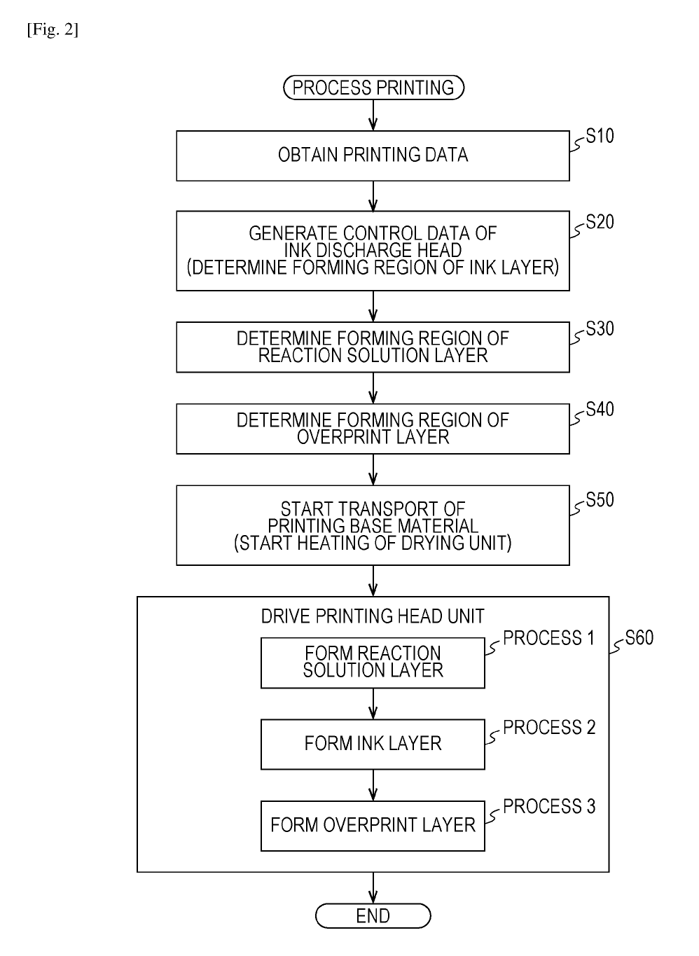

FIG. 2 is an explanatory diagram illustrating the flow of the printing processing which a control unit 11 executes. In a step S10, the control unit 11 obtains the above-described printing data PD. In a step S20, the control unit 11 generates the data for controlling the discharge of the ink by the ink discharge head 32i, on the basis of the printing data PD. Specifically, by performing the color separation of the images which are represented in the printing data PD, and performing the halftone processing per each color, the control data representing the timing of the ink droplets to be discharged by each of the nozzles in the respective ink discharge heads 32w, 32b, 32c, 32m, and 32y, is created. Furthermore, in the step S20, it can be interpreted that the region where the ink layer 82 is formed is determined. In the following step S30, the control unit 11 determines a forming region of the reaction solution layer 81 and a forming region of the overprint layer 83, based on a forming region of the ink layer 82 which is determined in the step S20.

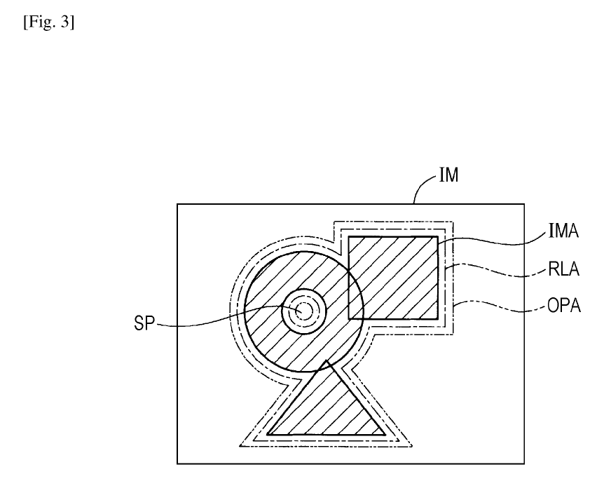

FIG. 3 is a schematic diagram for describing a forming region RLA of the reaction solution layer 81 and a forming region OPA of the overprint layer 83. In FIG. 3, a printing image IM is illustrated as an example. In FIG. 3, a forming region IMA of the ink layer 82 is illustrated as a region to which hatching is applied, and the forming regions RLA of the reaction solution layer 81 is illustrated by a chain line, and the forming region OPA of the overprint layer 83 is illustrated by a two point chain line.

The forming region IMA of the ink layer 82 is a region where one color ink of five color inks is colored by being discharged in the printing image IM. In the first embodiment, the reaction solution layer 81 is formed in the region which surrounds a whole of an outer periphery of the ink layer 82 including the forming region IMA of the ink layer 82. Accordingly, an outline of the forming region RLA of the reaction solution layer 81 is formed along an outline of the forming region IMA of the ink layer 82 on the outside of the forming region IMA of the ink layer 82. For example, the interval between the outline of the forming region RLA of the reaction solution layer 81 and the outline of the forming region IMA of the ink layer 82, may be approximately several mm. When a blank region SP being hollow is present in the ink layer 82, the outline of the forming region RLA of the reaction solution layer 81 is also positioned on the inside of the blank region SP. Furthermore, the interval between the outline of the forming region RLA of the reaction solution layer 81 and the outline of the forming region IMA of the ink layer 82 may not be fixed. The reaction solution layer 81 may be formed so as to bury the blank region SP.

In the first embodiment, the overprint layer 83 is formed in the region which surrounds a whole of an outer periphery of the reaction solution layer 81 including the forming region IMA of the ink layer 82 and the forming region RLA of the reaction solution layer 81. Accordingly, the outline of the forming region OPA of the overprint layer 83 is formed along the outline of the forming region RLA of the reaction solution layer 81 on the outside of the forming region RLA of the reaction solution layer 81. For example, the interval between the outline of the forming region OPA of the overprint layer 83 and the outline of the forming region RLA of the reaction solution layer 81, may be approximately several mm. When the blank region SP being hollow is present in the reaction solution layer 81, the outline of the forming region OPA of the overprint layer 83 is also positioned on the inside of the blank region SP. Furthermore, the interval between the outline of the forming region OPA of the overprint layer 83 and the outline of the forming region RLA of the reaction solution layer 81, may not be fixed. Moreover, the overprint layer 83 may be formed so as to bury the blank region SP.

In the steps of S30 and S40 (FIG. 2), the control unit 11 determines the regions RLA and OPA as described above, with respect to the forming region IMA of the ink layer 82. Therefore, the control data for controlling the discharge of the droplets from the respective nozzles of the reaction solution discharge head 32r and the head for overprinting 32p, is generated based on each of the determined regions RLA and OPA. In a step S50, the control unit 11 starts the transport of the printing base material 12 in the transport path 15 where the rotation and the drive of the base material roller 21, the rotating drum 31, and the winding roller 51 are started. At this time, the control unit 11 may start a preheating of the heating unit 42.

In a step S60, the liquid discharge heads 32r to 32p of the printing head unit 32 are driven, based on the control data which is created in the respective steps S20 and S30. In the printing apparatus 10 of the first embodiment, as described above, the reaction solution discharge head 32r, the ink discharge head 32i, and the head for overprinting 32p are sequentially arrayed from the upstream side. Therefore, in the printing execution unit 30, the printing image is formed by three continuous processes described hereinafter.

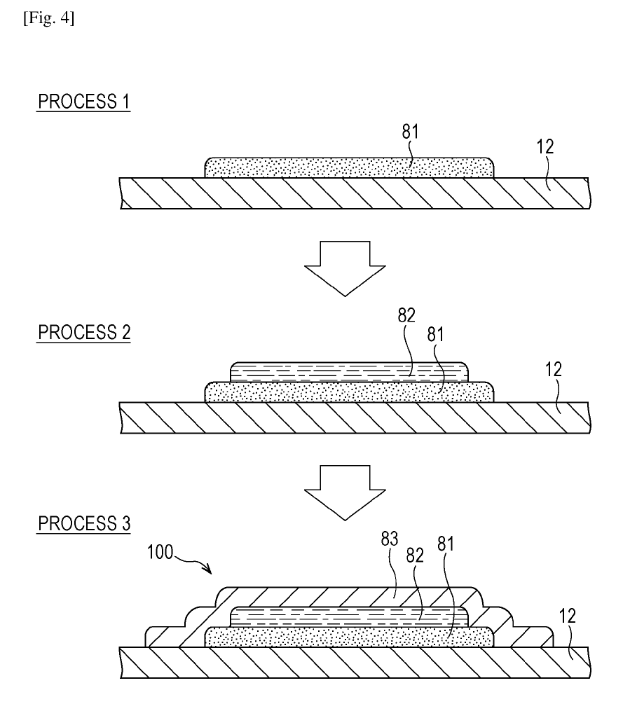

FIG. 4 is a schematic diagram illustrating forming processes of the printing image by the printing execution unit 30 in sequence of the forming processes. In a process 1 (upper stage of FIG. 4), by the reaction solution discharge head 32r, the reaction solution layer 81 is formed on the printing base material 12. In the first embodiment, the reaction solution discharge head 32r discharges the droplets of the reaction solution so that dots which are in the position adjacent to each other become in a state of a solid coating by being connected to each other. The “dot” means a point-shaped liquid layer which is formed by attaching (landing) the droplet to the printing base material 12. The “state of the solid coating” means a state where the dots adjacent to each other are connection to each other, and an underlayer is covered in the state of almost no gap between the dots. For example, the “state of almost no gap” is a state where the area of the gap per unit area in a dot forming region becomes a ratio of 10% or less.

In a process 2 (middle stage of FIG. 4), the ink layer 82 representing the image, is formed on the reaction solution layer 81 by the ink discharge head 32i. Since the color material among the ink layer 82 is flocculated at the landing position of the ink droplet by reacting with the flocculant among the reaction solution layer 81, the fixability at a desired position of the ink with respect to the printing base material 12 is enhanced. Accordingly, even when it takes time to dry the ink, it is suppressed that the color material flows away from the desired position, and the image quality of the printing image is enhanced.

In particular, in the first embodiment, as described in FIG. 3, the ink layer 82 is previously controlled so as to be settled within the forming region of the reaction solution layer 81, and the ink droplet is suppressed to be discharged on the outside of the reaction solution layer 81. Moreover, since an edge portion of the ink layer 82 is formed on the reaction solution layer 81, the outline of the printing image becomes sharp, and the image quality is enhanced. In addition, since the reaction solution layer 81 is formed in the region according to the forming region of the ink layer 82, it is suppressed that the reaction solution is used in surplus.

In a process 3 (lower stage of FIG. 4), by the head for overprinting 32p, the overprint layer 83 is formed on the reaction solution layer 81 and the ink layer 82. In the first embodiment, the head for overprinting 32p discharges the droplet of the overprint solution so that the state of the solid coating is made by connecting the adjacent dots to each other. In the first embodiment, the overprint layer 83 is formed so as to be in contact with the whole surface of the ink layer 82, an end portion of the reaction solution layer 81 which extends from the ink layer 82, and the surface of the printing base material 12 of the outer periphery region of the reaction solution layer 81.

After passing through the printing process of the above processes 1 to 3, by drying the respective layers 81 to 83 in the drying unit 40, a printed matter 100 is obtained. In the printed matter 100 which is obtained by the printing apparatus 10 of the first embodiment, the state where the whole of the reaction solution layer 81 is sealed by the overprint layer 83 is made, and barrier properties of the reaction solution layer 81 with respect to external environments is enhanced. Accordingly, even when the flocculant remains on the printing base material 12 as being unreacted with the color material, it is suppressed that the flocculant is in contact with moisture, and it is suppressed that an off-flavor such as acetic acid odor is generated, and it is suppressed that adhesiveness is affected by deliquescing.

In particular, in the first embodiment, since the overprint layer 83 is formed without the gap in the state of the solid coating, sealing properties of the flocculant is enhanced. As described above, in the first embodiment, the polyvalent metal salt is used as a flocculant. If being the overprint solution of the first embodiment containing the above-described resin material, since the overprint solution can be reacted with the flocculant of the polyvalent metal salt, it is possible to reduce the unreacted flocculant on the printing base material 12 by being consumed due to the reaction. In the first embodiment, since the reaction solution layer 81 which is not covered by the ink layer 82 is present on the outer periphery of the ink layer 82, it is possible to remarkably obtain effects of the consumption and the reduction of the unreacted flocculant due to the resin material in the overprint solution.

In addition, in the first embodiment, by the overprint layer 83, protective properties of the printing image which is formed by the ink layer 82 are increased, and durability (including abrasion resistance and light resistance) of the ink layer 82 is enhanced. Still more, since the ink layer 82 is covered by the overprint layer 83 immediately after the ink layer 82 is formed in the printing apparatus 10 of the first embodiment, it is suppressed that dirt and dust are mixed between the overprint layer 83 and the ink layer 82, and it is suppressed that the printing quality is lowered.

### Summary of First Embodiment

As described above, according to the printing process which the printing apparatus 10 of the first embodiment executes, the region to which the reaction solution containing the flocculant is coated is covered by the overprint layer in the printing base material 12. Accordingly, even when the flocculant remains in the printed matter 100, it is suppressed that the off-flavor is generated by the flocculant, and the unintended adhesiveness occurs on the surface of the printed matter 100. In addition thereto, the generation of a failure which is caused by the remaining flocculant is suppressed.

### B. Second Embodiment

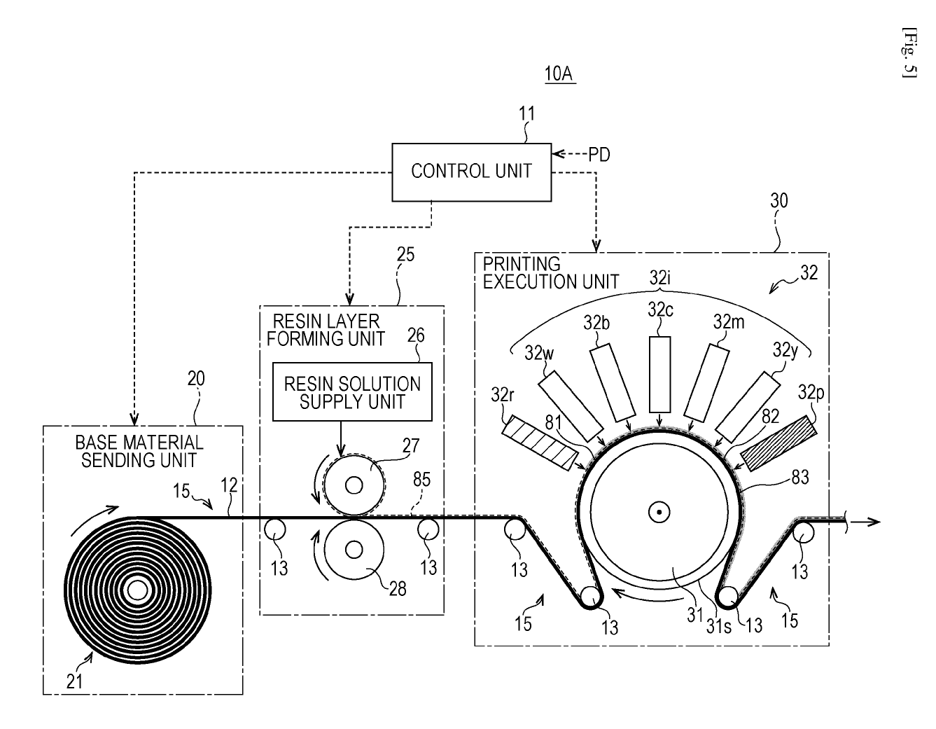

FIG. 5 is a schematic diagram illustrating a configuration of a printing apparatus 10A as a second embodiment of the present invention. In FIG. 5, for the sake of convenience, the illustration of the drying unit 40 and the base material winding unit 50 which are installed on the downstream side of the printing execution unit 30, is omitted. The printing apparatus 10A of the second embodiment is almost the same as the printing apparatus 10 of the first embodiment, except for a point that a resin layer forming unit 25 is added between the base material sending unit 20 and the printing execution unit 30.

The resin layer forming unit 25 forms a resin layer 85 for enhancing adhesion of each droplet which is discharged in the printing executing unit 30 with respect to the printing base material 12, on the printing face of the printing base material 12 during the transport. The resin layer forming unit 25 is configured as a so-called roll coater, and includes a resin solution supply unit 26, a coating roller 27, and a supporting roller 28. The resin solution supply unit 26 accumulates a resin solution which is a raw material of the resin layer 85, and attaches the resin solution to the whole circumferential side face of the coating roller 27.

In the second embodiment, as a resin solution, a solution of dispersing at least one of the following resins in the inorganic solvent or the organic solvent is used. If being the resin layer 85 which is formed by the following resin, it is possible to enhance the adhesion of the reaction solution layer 81, the ink layer 82, and the overprint layer 83 with respect to the printing base material 12. Moreover, when the printing base material 12 has water absorbency, it can be suppressed that the liquid is absorbed into the printing base material 12 by the resin layer 85. Accordingly, it is suppressed that the reaction solution which is coated on the printing base material 12 is absorbed into the printing base material 12, and the desired flocculation reaction with respect to the color material among the ink is not obtained in the reaction solution layer 81.

(List of Examples of the Resins which are Contained in the Resin Solution)

Styrene acrylic-based resin/polyethylene-based resin/urethane-based resin/polyester-based resin/acrylic-based resin

The coating roller 27 has a length of the same degrees as the width in the direction which is perpendicular to a transport direction of the printing base material 12, and is arranged so that the whole of the circumferential side face thereof in the width direction is in contact with the printing face of the printing base material 12 by the surface contact. The coating roller 27 is rotated at the rotational speed according to the command of the control unit 11. The supporting roller 28 has almost the same size as the coating roller 27, and is arranged to be opposite to the coating roller 27 by pinching the printing base material 12, and supports the printing base material 12.

The printing base material 12 which is sent out from the base material sending unit 20, is transported to the resin layer forming unit 25. The printing base material 12 is sent in between the coating roller 27 and the supporting roller 28 in the resin layer forming unit 25. As described above, since the resin solution which is supplied from the resin solution supply unit 26 is attached onto the whole circumferential side face of the coating roller 27, the printing base material 12 passes between the two rollers 27 and 28, and thereby, the resin solution is coated to the whole of the printing region of the printing base material 12, and the resin layer 85 is formed.

The printing base material 12 where the resin layer 85 is formed is transported to the printing execution unit 30. In the printing execution unit 30, the reaction solution layer 81, the ink layer 82, and the overprint layer 83 are sequentially formed on the resin layer 85, in the same manner as the manner described in the first embodiment. After passing through the printing process of the printing execution unit 30, the printing base material 12 is transported to the base material winding unit 50 through the drying unit 40, and is wound.

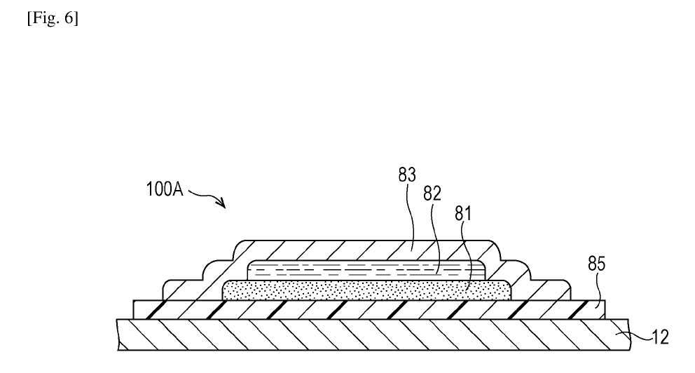

FIG. 6 is a schematic diagram of a printed matter 100A which is obtained by the printing apparatus 10A according to the second embodiment. The printed matter 100A is almost the same as the printed matter 100 of the first embodiment, except for the point that the resin layer 85 is interposed between the end portions of the printing base material 12, the reaction solution layer 81, and the overprint layer 83.

In the printed matter 100A of the second embodiment, wettability of the surface of the printing base material 12 becomes good by the resin layer 85. Accordingly, the adhesiveness of the overprint layer 83 with respect to the printing base material 12 is enhanced, and the state where the reaction solution layer 81 is more reliably sealed is made. Moreover, the adhesiveness of the reaction solution and the ink with respect to the printing base material 12 is enhanced, and the image quality of the printing image is enhanced.

As described above, if being the printing apparatus 10A of the second embodiment, it is effectively suppressed that the failure which is caused by the flocculant remaining in the printed matter 100A is generated, in comparison with the printing apparatus 10 of the first embodiment. Moreover, if being the printing apparatus 10A of the second embodiment, it is possible to enhance the image quality of the printing image in the printed matter 100A. In addition thereto, if being the printing apparatus 10A of the second embodiment and the printed matter 100A which is obtained by the printing apparatus 10A, at least, it is possible to obtain the same effects as the effects described in the first embodiment.

### C. Modification Examples

### C1. Modification Example 1

In the respective embodiments described above, the control unit 11 executes the printing process of the processes 1 to 3 in the printing executing unit 30, after determining the forming region IMA of the ink layer 82, the forming regions RLA of the reaction solution layer 81, and the forming region OPA of the overprint layer 83 (FIG. 2). On the contrary, per one line or a plurality of predetermined lines of the printing image, the control unit 11 may form the printing image by repeating the processing of executing the printing processes, while determining the printing regions of the respective layers 81 to 83. Even if being configured described above, the configuration is not substantially different from the configurations of the respective embodiments.

### C2. Modification Example 2

In the respective embodiments described above, the polyvalent metal salt is used as a flocculant which is contained in the reaction solution. On the contrary, other chemicals may be used as a flocculant which is contained in the reaction solution. As a flocculant, if being a material which is capable of flocculating the color material among the ink, it is favorable, and for example, inorganic acid such as hydrochloric acid, sulfuric acid or phosphoric acid may be used, and organic acid such as carboxylic acid, sulfonic acid, acetic acid or methanesulfonic acid may be used.

### C3. Modification Example 3

In the respective embodiments described above, the overprint layer 83 is formed by having the area which is larger than the reaction solution layer 81 so that the outer periphery thereof surrounds the outer periphery of the reaction solution layer 81. On the contrary, the overprint layer 83 may be formed in the same region as the reaction solution layer 81 so that the outer periphery thereof overlaps with the outer periphery of the reaction solution layer 81. Alternatively, the overprint layer 83 may be formed to cover only a portion of the region where the reaction solution layer 81 is formed. Moreover, the overprint layer 83 may be formed so as to cover only a portion of the ink layer 82. The overprint layer 83 may be formed across the whole of the printing region, regardless of the forming region RLA of the reaction solution layer 81 and the forming region IMA of the ink layer 82.

### C4. Modification Example 4

In the respective embodiments described above, the reaction solution layer 81 is formed so that the forming region IMA of the ink layer 82 is settled within the forming region RLA. On the contrary, the reaction solution layer 81 may be formed in the same region as the ink layer 82 so that the outer periphery thereof overlaps with the outer periphery of the ink layer 82. Accordingly, it is suppressed that the remaining flocculant is generated without reacting with the color material on the printing base material 12. Moreover, the reaction solution layer 81 may be formed only in a portion of the forming region IMA of the ink layer 82. The reaction solution layer 81 may be formed across the whole of the printing region, regardless of the forming region IMA of ink layer 82.

### C5. Modification Example 5

In the respective embodiments described above, the overprint layer 83 is formed by the solid coating of the overprint solution so that the reaction solution layer 81 and the ink layer 82 are covered without the gap. On the contrary, the overprint layer 83 is favorable even when the reaction solution layer 81 and the ink layer 82 are not covered without the gap, and for example, the overprint layer 83 may be formed in a halftone dot shape. In this case, the concentration of the halftone dots is preferably 50% or more, and more preferably 80% or more. The “concentration of the halftone dots” is a ratio which the area of the dots that is formed by the droplets occupied per unit area occupies. Moreover, in the respective embodiments described above, the reaction solution layer 81 is formed by the solid coating of the reaction solution. On the contrary, the reaction solution layer 81 may be formed so as to have the gap, and for example, the reaction solution layer 81 may be formed in the halftone dot shape. In this case, the concentration of the halftone dots in the reaction solution layer 81 is preferably 50% or more, and more preferably 80% or more.

### C6. Modification Example 6

In the respective embodiments described above, the overprint solution is configured of the resin which is capable of reacting with the flocculant as a main ingredient. On the contrary, the overprint solution may be configured of the resin which does not react with the flocculant as a main ingredient. Moreover, in the respective embodiments described above, the overprint layer 83 configures the transparent resin film after the drying. In contrast, the overprint layer 83 may not have a high transparency, and is favorable if the printing image that is formed by the ink layer 82 of the underlying layer, has the light-transmitting properties which can be identified. Still more, for example, the overprint layer 83 is configured as a colored semitransparent layer, and thereby, the overprint layer 83 may have a function as one of elements configuring the color of the printing image.

### C7. Modification Example 7

In the respective embodiments described above, the overprint layer 83 is formed by the discharge of the overprint solution due to the head for overprinting 32p. On the contrary, the overprint layer 83 may be formed by the means other than the head for overprinting 32p. For example, the overprint layer 83 may be formed by the coating of the overprint solution due to a spray or the roll coater.

### C8. Modification Example 8

In the respective embodiments described above, the reaction solution layer 81 is formed by the discharge of the reaction solution due to the reaction solution discharge head 32r. On the contrary, the reaction solution layer 81 may be formed by the means other than the reaction solution discharge head 32r. For example, the reaction solution layer 81 may be formed by the coating of the reaction solution due to the spray or the roll coater.

### C9. Modification Example 9

In the respective embodiments described above, along the circumferential side face of the rotating drum 31, the reaction solution discharge head 32r, the ink discharge head 32i, and the head for overprinting 32p are sequentially arrayed from the upstream side to the downstream side. On the contrary, the rotating drum 31 may be omitted, and the liquid discharge heads 32r to 32p may be arrayed in a straight line shape on the transport path 15. Moreover, the reaction solution discharge head 32r, the ink discharge head 32i, and the head for overprinting 32p may not be sequentially arrayed from the upstream side to the downstream side in the transport path 15. For example, the reaction solution discharge head 32r, the ink discharge head 32i, and the head for overprinting 32p are configured to be movable, and by the control of the control unit 11, the respective layers 81 to 83 may be formed by sequentially moving to the printing position. In addition thereto, for example, the head for overprinting 32p may be arranged in the position away from the ink discharge head 32i, and may be arranged on the downstream side of the drying unit 40.

### C10. Modification Example 10

In the respective embodiments described above, the reaction solution discharge head 32r and the head for overprinting 32p, have the nozzle resolution which is lower than the ink discharge head 32i. In contrast, the reaction solution discharge head 32r and the head for overprinting 32p may have the same nozzle resolution as the ink discharge head 32i, and may have the nozzle resolution which higher than the ink discharge head 32i.

### C11. Modification Example 11

In the respective embodiments described above, the printing apparatuses 10 and 10A are configured as a line printer which is capable of performing the continuous printing on the belt-shaped printing base material 12. On the contrary, the printing apparatuses 10 and 10A may be configured as a serial printer. In this case, the liquid discharge heads 32r to 32p may not be configured as a line head, and may be configured as a head which is capable of reciprocally moving in the width direction of the printing base material 12. Moreover, the printing apparatuses 10 and 10A may not have the configuration of executing the continuous printing with respect to the belt-shaped printing base material 12, and may have a configuration for executing the printing one by one with respect to the printing base material 12 which is separated by the predetermined size.

### C12. Modification Example 12

In the second embodiment described above, the resin layer forming unit 25 is configured as a roll coater. On the contrary, the resin layer forming unit 25 may have other configurations. For example, the resin layer forming unit 25 may have a configuration of forming the resin layer 85 by coating the resin solution to the printing base material 12 due to the ink jet system.

### C13. Modification Example 13

In the second embodiment described above, the printed matter 100A having the resin layer 85 is created by the printing apparatus 10A having the resin layer forming unit 25. On the contrary, the printed matter 100A may be created by using the printing base material 12 where the resin layer 85 is previously formed on the printing face, in the printing apparatus 10 of the first embodiment.

### C14. Modification Example 14

The printing apparatuses 10 and 10A of the respective embodiments described above, include five color ink discharge heads 32w, 32b, 32c, 32m, and 32y. In contrast, the printing apparatuses 10 and 10A may have a configuration of including the ink discharge heads which are smaller than five color ink discharge heads, and may have a configuration of including the ink discharge heads which are larger than five color ink discharge heads.

The present invention is not limited to the above-described embodiments, examples, and modification examples, and can be realized in various types of configurations in the scope without departing from the gist thereof. For example, it is possible to appropriately perform the replacement or the combination of technical features of the embodiments, examples, and modification examples corresponding to the technical features of the respective forms which are written in the page of the summary of the invention, in order to solve a portion or all of the above-described problems, or in order to achieve a portion or all of the above-described effects. Moreover, the technical features can be appropriately deleted, unless being described as an indispensable feature in the present specification.

### REFERENCE SIGNS LIST

10, 10A Printing apparatus
11 Control unit
12 Printing base material
13 Transport roller
15 Transport path
20 Base material sending unit
21 Base material roller
25 Resin layer forming unit
26 Resin solution supply unit
27 Coating roller
28 Supporting roller
30 Printing execution unit
31 Rotating drum
31s Circumferential side face
32 Printing head unit
32r Reaction solution discharge head
32i (32w, 32b, 32c, 32m, 32y) Ink discharge head
32p Head for overprinting
40 Drying unit
42 Heating unit
50 Base material winding unit
51 Winding roller
81 Reaction solution layer
82 Ink layer
83 Overprint layer
85 Resin layer
100, 100A Printed matter

1. A printing apparatus comprising:
a first layer forming unit that is capable of forming a reaction solution layer which is a layer of a reaction solution containing a flocculant onto a recording medium;
an ink discharge unit that is capable of discharging an ink containing a color material on the reaction solution layer; and
a second layer forming unit that is capable of forming an overprint layer which is a layer of an overprint solution so as to be positioned on the reaction solution layer, with respect to the recording medium where the ink is discharged.

2. The printing apparatus according to claim 1, wherein the second layer forming unit forms the overprint layer, so that an outer periphery of the overprint layer overlaps with an outer periphery of the reaction solution layer, or so that an outer periphery of the overprint layer surrounds an outer periphery of the reaction solution layer.

3. The printing apparatus according to claim 1, wherein the second layer forming unit forms the overprint layer by a solid coating of the overprint solution.

4. The printing apparatus according to claim 1, wherein the overprint solution contains an ingredient which is capable of reacting with the flocculant.

5. The printing apparatus according to claim 1, wherein the flocculant contains a polyvalent metal salt.

6. The printing apparatus according to claim 1, wherein the second layer forming unit includes a liquid discharge head that discharges the overprint solution.

7. The printing apparatus according to claim 1, further comprising:
a transport path where the recording medium is transported, wherein the first layer forming unit, the ink discharge unit, and the second layer forming unit are sequentially arranged from an upstream side to a downstream side in the transport path.

8. The printing apparatus according to claim 7, wherein the transport path includes a rotating drum of which an outer peripheral face is capable of supporting the recording medium, and
the first layer forming unit, the ink discharge unit, and the second layer forming unit are arranged in a position which is opposite to the outer peripheral face of the rotating drum.

9. The printing apparatus according to claim 1, further comprising:
a resin layer forming unit that forms a resin layer, onto the recording medium before the reaction solution layer is formed.

10. A printing method comprising:
a first layer forming step of forming a reaction solution layer which is a layer of a reaction solution containing a flocculant onto a recording medium;
an ink discharging step of discharging an ink containing a color material on the reaction solution layer; and
a second layer forming step of forming an overprint layer which is a layer of an overprint solution on the reaction solution layer.

11. A printed matter comprising:
a recording medium; and
a printing region where a reaction solution layer which is formed by a reaction solution containing a flocculant, an ink layer which is formed by an ink containing a color material, and an overprint layer which is formed by an overprint solution, are sequentially stacked from a surface of the recording medium in the recording medium.
